(19) United States
(12) Patent Application Publication
(10) Pub. No.: US 2013/0151329 A1
(43) Pub. Date: Jun. 13, 2013

(54) MARKETING SYSTEM AND METHOD FOR DIRECTING CUSTOMER FOOTFALL

(71) Applicants: Ayman A. Azzi, Bikfaya (LB); Samir Chrem, East Weymouth, MA (US)

(72) Inventors: Ayman A. Azzi, Bikfaya (LB); Samir Chrem, East Weymouth, MA (US)

(21) Appl. No.: 13/517,557

(22) Filed: Jun. 13, 2012

Related U.S. Application Data
(60) Provisional application No. 61/496,048, filed on Jun. 13, 2011.

(51) Int. Cl. G06Q 30/02

(52) U.S. Cl. CPC G06Q 30/0207
USPC 705/14.39; 705/14.1

(57) ABSTRACT

Disclosed is a method of marketing to a prospective customer comprises: creating an offer for submittal to the prospective customer; enabling the prospective customer to access and retrieve at least one of a coupon, a barcode, a data matrix code, a partial numbering sequence, and a password related to the offer; and accepting, from the prospective customer, at least one of the coupon, the barcode, the data matrix code, the partial numbering sequence, and the password at a pre-designated validation site.

### CROSS REFERENCE TO RELATED APPLICATION

The present Application is related to Provisional Patent Application entitled “System and Method for Directing Customer Footfall in a Commercial Establishment,” filed 13 Jun. 2011 and assigned filing No. 61/496,048, incorporated herein by reference in its entirety.

### FIELD OF THE INVENTION

This invention relates to a marketing system and method for managing customer flow and movement in retail shopping establishments such as department stores, shopping malls, and other commercial transactional establishments.

### BRIEF SUMMARY OF THE INVENTION

In one aspect of the present invention, a method of marketing to a prospective customer comprises: creating an offer for submittal to the prospective customer; enabling the prospective customer to access and retrieve at least one of a coupon, a barcode, a data matrix code, a partial numbering sequence, and a password related to the offer; and accepting, from the prospective customer, at least one of the coupon, the barcode, the data matrix code, the partial numbering sequence, and the password at a pre-designated validation site.

In another aspect of the present invention, a method of directing customer footfall in a commercial retail establishment comprises: forming a marketing agreement between at least one merchant and the commercial retail establishment; enabling a prospective customer to access and retrieve, via the Internet, any one of a coupon, a barcode, a data matrix code, a partial numbering sequence, and a password related to an offer specified in said marketing agreement; providing, as a pre-designated validation site, at least one of an automated kiosk, a kiosk with an attendant, a mobile attendant, or a specified agent located within the premises of the commercial retail establishment; and accepting, from the prospective customer, any of the coupon, the barcode, the data matrix code, the partial numbering sequence, and the password at the pre-designated validation site.

In still another aspect of the present invention, a marketing system for increasing customer footfall at a pre-specified commercial location comprises: a host server including a marketing application, the marketing application transmitting via the Internet at least one of a coupon, a barcode, a data matrix code, a partial numbering sequence, and a password related to an offer made by a merchant; a communication device accessible by a prospective customer, the communication device for receiving at least one of the coupon, the barcode, the data matrix code, the partial numbering sequence, and the password related to the offer; and a validation site designated in the offer, the validation site for enabling said prospective customer to physically have the offer validated.

The additional features and advantage of the disclosed invention is set forth in the detailed description which follows, and will be apparent to those skilled in the art from the description or recognized by practicing the invention as described, together with the claims and appended drawings.

### DESCRIPTION OF DRAWINGS

FIG. 1 is a diagrammatical representation of a marketing system for directing footfall in a commercial establishment, in accordance with the present invention; and

FIG. 2 is a flow diagram illustrating operation of the marketing system of FIG. 1.

### DETAILED DESCRIPTION OF THE INVENTION

The present invention is directed to management of customer footfall, that is, a method of directing customers to a desired shopping location in accordance with a predetermined publicity program or other strategy established by one or more member merchants.

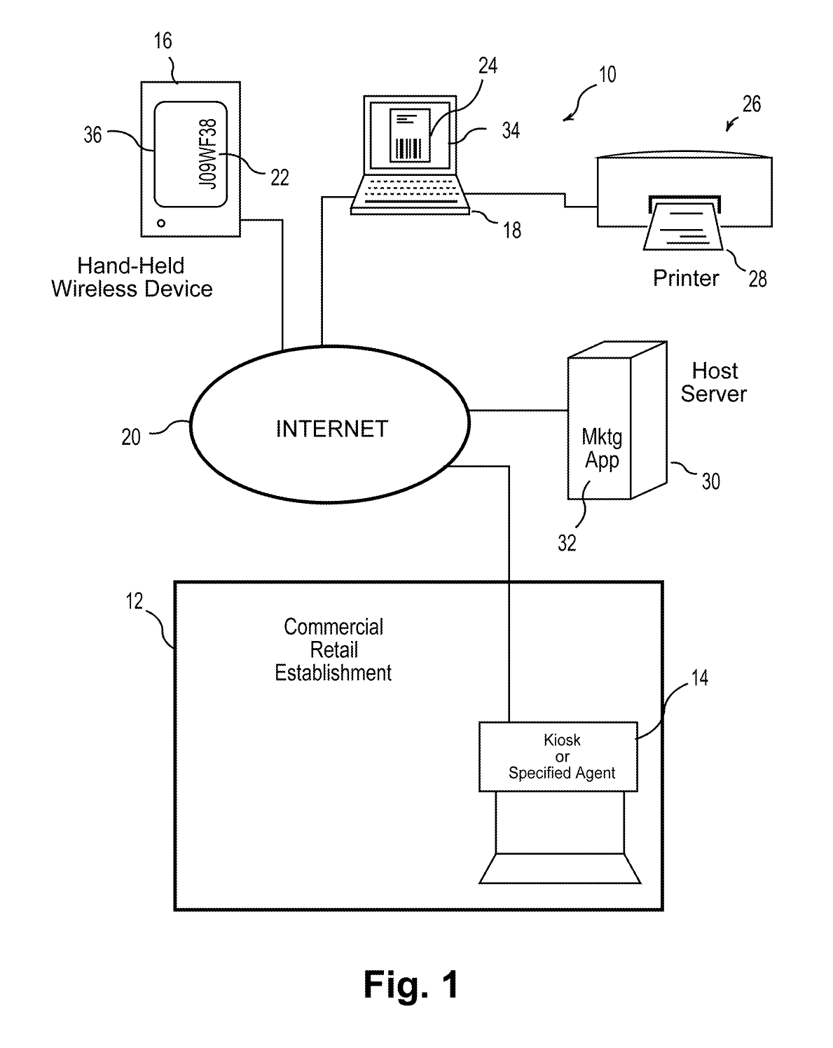

FIG. 1 is a diagrammatical illustration of a system 10 for directing footfall in a commercial establishment, in accordance with the present invention. One or more merchants or vendors (not shown), such as clothing manufacturers or service providers, may have established one or more agreements with one or more commercial retail establishments 12 for advantageously managing customer footfall, as explained in greater detail below.

A prospective customer (not shown), targeted by the merchant members via a publicity program, for example, may access the system 10 by first establishing a connection to the Internet 20. This may be accomplished, for example, by means of a communications device, such as (i) a hand-held wireless tablet 16, (ii) a personal computer 18 or other computing device, (iii) a mobile electronic or communication device such as a cell phone, or (iii) any other communications device functioning in accordance with Bluetooth standards.

Interactive contact between the prospective customer and the program offered by the merchant is preferably made with access to a merchant commercial web site, where the contact may be initiated by either the customer while surfing the web, or by the commercial site via an e-mail transmittal or a solicitation sent to the prospective customer or a communication initiated via short message service (SMS), for example. In an exemplary embodiment, the solicitation may be sent to the prospective customer whether or not the prospective customer is online.

Such contact may result in an offer being made to the prospective customer by the merchant commercial web site, the offer becoming valid only when the customer consummates a financial transaction by making a purchase: (i) with the merchant represented by the commercial web site, and (ii) at a pre-designated location specified by the merchant. Accordingly, the merchant thus has flexibility in determining how, where, and when the customer footfall is to be controlled.

In an exemplary embodiment, the proposed commercial transaction may allow the customer to provide payment for a purchase either before or after the proposed transaction has been executed. As shown in the illustration, the offer may include a password 22 or other code provided to the customer for verifying the offer or solicitation. Alternatively, the on-line offer may display to the prospective customer a coupon, or a barcode 24 or data matrix code (not shown) that can be printed out using a printer 26, to function as a customer coupon 28.

In yet another exemplary embodiment, the merchant may provide a partial or incomplete numbering sequence (not shown), sent by SMS for example, where the customer is required to complete the numbering sequence to enable execution of a proposed transaction or the purchase. Advantageously, marketing data may be collected in a system using such numbering sequences for subsequent use by the merchant.

It should be understood that, although the password 22 is shown as having been provided to a display screen 36 in the hand-held wireless tablet 16 and the barcode 24 is shown as having been provided on a display 34 in the personal computer 18, the password 22 may alternatively be provided to the personal computer 18 and the barcode 24 or data matrix code may likewise be provided to the hand-held wireless tablet 16. Or, the coupon 28 may include: (i) the password 22, (ii) the barcode 24, (iii) the data matrix code, (iv) a partial numbering sequence, or (iv) a combination of the password 12, the barcode 24, the partial numbering sequence, and the data matrix code.

A host server 30 may functions to execute a marketing application 32, in accordance with the present invention, by which the barcode 24 and/or the password 22 and/or the numbering sequence is provided to the customer via the hand-held wireless tablet 16 and/or the personal computer 18 and/or the coupon 28. The marketing application 32 functions in accordance with any agreement or business arrangement made between the commercial establishment 12 and one or more merchants or vendors. The action of executing the marketing application 32 may be initiated by the merchant, and may be part of a promotional program, or other commercial marketing activity, as well known in the relevant art.

The commercial establishment 12, which may be, without limit, a shopping mall, a “mom and pop” store, a superstore, a chain store, a charity-based retail facility, a department store, or any other type of commercial establishment. The commercial establishment may form the agreement with the merchant(s) to facilitate validation of one or more coupons 28 acquired by the solicited customer. The validation site 14 may include, for example, an automated kiosk, a kiosk with an attendant, a mobile attendant, or specified agent of the merchant within the premises of the commercial establishment, set up to accept and validate the coupon 28. Preferably, the customer is required to physically visit or access the validation site 14 and present the coupon 28, or the barcode 24, or the password 22, or the data matrix code, or the partial numbering sequence, in order to receive some sort of value from the merchant(s).

In an exemplary embodiment, the marketing application 32 may further function to correlate the type of proposed transaction with a particular location in the commercial establishment. For example, validation for a coupon related to children's items may require the customer to access a kiosk or validation site 14 located in a “ladies” section of the commercial establishment, rather than in the “men's” section. Extending this feature of the marketing application 32 within a large commercial establishment can provide for directed, preferred, or optimized, customer footfall among different facilities in the establishment. Additional footfall can be routed, for example, to areas in the commercial establishment having a low incidence of customer transactions. Accordingly, an owner of the large commercial establishment may realize increased revenues, or otherwise optimize revenue, from rental charges for these facilities.

This action of coupon presentment may include simply presenting a printed password 22 or barcode 24, or may include using a scanner (not shown) at the validation site to scan the barcode 24 from the coupon 28 or from the display screen 36 on the hand-held wireless tablet 16. In an alternative embodiment, the customer may be required to physically visit the validation site 14 in order to both pick up and validate the coupon 28. In return for the validation action, the merchant may provide value to the customer, at step 52, such as a discounted price on an item or service, or an item given free of charge.

In an exemplary embodiment, the validation site 14 is intentionally placed so as to manage and direct customer footfall in accordance with an agreement established between the merchant(s) and the commercial establishment 12. This may include, for example, placing a kiosk in a lightly-trafficked area of a department store so as to increase customer footfall in that area. Alternatively, such an agreement may require that the specified agent be located at a major entrance to a shopping mall so as to provide greater exposure to a facility near the entrance.

It can be appreciated by one skilled in the relevant art that the disclosed method requires that the prospective customer physically visit a designated location previously determined by a merchant to be a commercial location in need of additional customer footfall or activity. Accordingly, unlike some marketing schemes in the present state of the art, the prospective customer responding to an offer in accordance with the present disclosure cannot avail himself of proffered merchant value by merely accessing the merchant website and remaining at a computer screen.

Preferably, the location of the validation site 14 can be changed from time to time, in accordance with the requirements of a business administration group, or other such business group, in the commercial establishment 12. It can be appreciated that these requirements may be ascertained by the appropriate business group, or may be produced by the application 30 in response to an evaluation of footfall statistics collected by a business group.

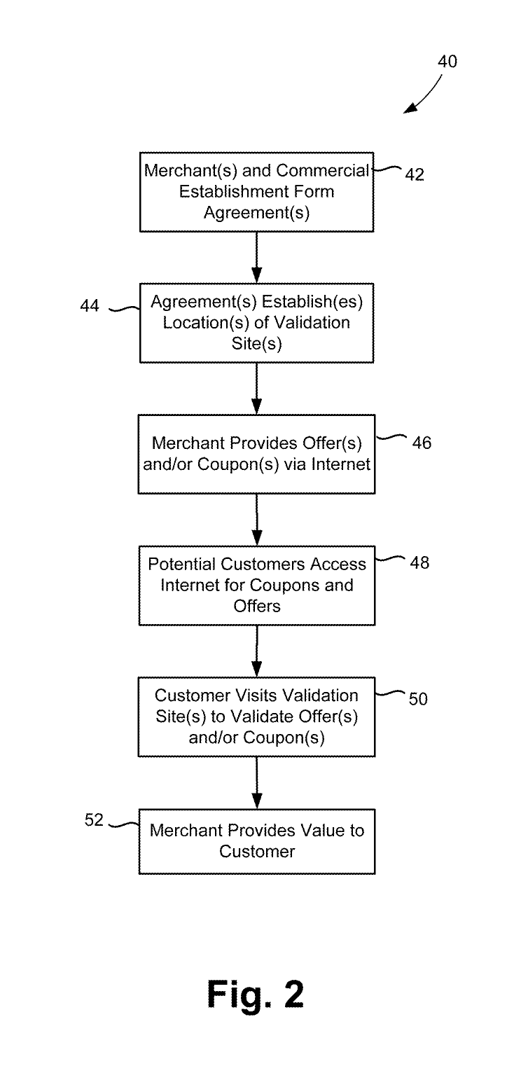

In an exemplary embodiment, a marketing program may be conceived and executed in accordance with a flow diagram 40, in FIG. 2. One or more merchants, and one or more commercial establishments, may communicate over a period of time to formulate a marketing plan, promotion, or other mutually-beneficial agreement intended to increase, or redirect, customer footfall at one or more target commercial establishments 12, at step 42. Such an agreement may include, among other recitals, the number and location of one or more validation sites 14, and the dates and duration of operation of the validation sites 14.

The merchants, may then agree to create and provide offer and promotion details, in an agreement, with accompanying coupons, barcodes, and/or passwords, for example, via the Internet 20, at step 46, for retrieval and consideration by prospective customers. A particular prospective customer may then select an attractive offer or promotion, retrieve the requisite barcode and/or coupon, and/or a partial numbering sequence, at step 48, and then may visit an appropriate validation site 14. The merchant, or a merchant agent, or an automated kiosk, may accept the requisite barcode and/or coupon and/or the partial numbering sequence, from the prospective customer, at step 50. Upon completing a purchase, or other requirement, the customer may receive some type of value from the respective merchant, at step 52.

It is to be understood that the description herein is only exemplary of the invention and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A method of marketing to a prospective customer, said method comprising the steps of:
creating an offer for submittal to the prospective customer;
enabling the prospective customer to access and retrieve at least one of a coupon, a barcode, a data matrix code, a partial numbering sequence, and a password related to said offer; and
accepting, from the prospective customer, said at least one of said coupon, said barcode, said data matrix code, said partial numbering sequence, and said password at a pre-designated validation site.

2. The method of claim 1 wherein said pre-designated validation site comprises at least one of an automated kiosk, a kiosk with an attendant, a mobile attendant, or a specified agent located within the premises of a commercial retail establishment.

3. The method of claim 1 wherein said step of enabling the prospective customer comprises the step of providing said offer to the prospective customer via the Internet.

4. The method of claim 1 wherein said step of creating comprises the step of forming a marketing agreement between at least one merchant and at least one commercial retail establishment.

5. The method of claim 1 wherein the customer accesses and retrieves said offer using at least one of a hand-held wireless tablet, a personal computer, a mobile electronic device, a mobile communication, a cell phone, or a communication device functioning in accordance with Bluetooth standards.

6. A method of directing customer footfall in a commercial retail establishment, said method comprising the steps of:
forming a marketing agreement between at least one merchant and the commercial retail establishment;
enabling a prospective customer to access and retrieve, via the Internet, any one of a coupon, a barcode, a data matrix code, a partial numbering sequence, and a password related to an offer specified in said marketing agreement;
providing, as a pre-designated validation site, at least one of an automated kiosk, a kiosk with an attendant, a mobile attendant, or a specified agent located within the premises of the commercial retail establishment; and
accepting, from said prospective customer, any of said coupon, said barcode, said data matrix code, said partial numbering sequence, and said password at said pre-designated validation site.

7. The method of claim 6 further comprising the step of providing value to said prospective customer in response to said step of accepting.

8. The method of claim 6 further comprising the step of printing out at least one of said coupon, said barcode, said data matrix code, said partial numbering sequence, and said password at before said prospective customer visits said pre-designated validation site.

9. The method of claim 6 wherein said offer is provided to said prospective customer when said prospective customer is off-line.

10. A marketing system for increasing customer footfall at a pre-specified commercial location comprises:
a host server including a marketing application, said marketing application transmitting via the Internet at least one of a coupon, a barcode, a data matrix code, a partial numbering sequence, and a password related to an offer made by a merchant;
a communication device accessible by a prospective customer, said communication device for receiving said at least one of said coupon, said barcode, said data matrix code, said partial numbering sequence, and said password related to said offer; and
a validation site designated in said offer, said validation site for enabling said prospective customer to physically have said offer validated.

11. The marketing system of claim 10 wherein said offer is validated by at least one of a merchant, an agent of said merchant, or an automated merchant kiosk present in said validation site.
